(19) United States
(12) Patent Application Publication
(10) Pub. No.: US 2020/0262235 A1
(43) Pub. Date: Aug. 20, 2020

(54) CANVAS FLOCKING DIAMOND PICTURE

(71) Applicant: Jinping Wang, Yiwu (CN)

(72) Inventors: Jinping WANG, YIWU (CN); Alexandre Perrier, Los Angeles, CA (US)

(21) Appl. No.: 16/284,688

(22) Filed: Feb. 25, 2019

(30) Foreign Application Priority Data
Feb. 18, 2019 (CN) 201920205215.5

(51) Int. Cl. B44C 1/00; D06C 7/02; D06N 3/04; D06M 23/08; D06N 3/00; D06P 5/04

(52) U.S. Cl. CPC B44C 1/00; D06C 7/02; D06N 3/042; D06M 23/08; A47G 1/06; D06P 5/04; D06N 2213/03; D06N 2211/12; D06N 2203/041; D06N 3/0006

(57) ABSTRACT

The disclosure discloses a canvas flocking diamond picture, and relates to the technical field of canvas flocking diamond picture devices and making methods, solving the problem that the gray cloth of diamond canvas is shrunk after encountering water so that the diamond picture becomes uneven. The picture frame is internally provided with a protective film and a canvas; the upper end surface of the canvas is provided with a flash layer; an ink-receiving layer is arranged under the flash layer; an upper back cover layer is arranged under the ink-receiving layer; a cingico layer is arranged under the upper back cover layer; a lower back cover layer is arranged under the cingico layer; a flocking layer is arranged under the lower back cover layer; an adhesive layer is arranged between the lower back cover layer and the flocking layer.

### CROSS-REFERENCE TO RELATED APPLICATIONS

This application is claims priority to Chinese Patent Application No. 201920205215.5 with a filing date of Feb. 18, 2019. The content of the aforementioned application, including any intervening amendments thereto, is incorporated herein by reference.

### TECHNICAL FIELD

The disclosure relates to the technical field of canvas flocking diamond picture devices and making methods, and particularly relates to a canvas flocking diamond picture.

### BACKGROUND OF THE PRESENT INVENTION

A diamond picture is, called a DIY diamond picture, and its creativity origins from currently popular hand embroidered painting. A creative designer organically combines artificial crystal flat base round diamonds and excellently designed patterns, a painter only needs to adhere a diamond extracted by a diamond-adhering tool to a corresponding color spot on a canvas, thereby completing the pasting of one diamond. Then, each color region is slowly filled to finally form a picture inlaid with different color diamonds.

At present, the gray cloth of the diamond canvas on the market is shrunk after encountering water so that the diamond picture becomes uneven; meanwhile, the back surface of the diamond, picture is mostly made of chemical fabric or cotton linen and the like so that wrinkles are generated, thereby affecting appearance and texture. Thus, it is urgent to develop a canvas flocking diamond picture on the market to help people to solve the existing problems.

### SUMMARY OF PRESENT INVENTION

The objective of the disclose is to provide a canvas flocking diamond picture to solve the problem that the gray cloth of the diamond canvas is shrunk after encountering water so that the diamond picture becomes uneven, which is proposed in the above background.

In order to realize the above objective, the disclosure provides the following technical solution: a canvas flocking diamond picture comprises a picture frame, wherein, the picture frame is internally provided with a protective film and a canvas, and the protective film is located at one side of the canvas; the upper end surface of the canvas is provided with a flash layer; an ink-receiving layer is arranged under the flash layer; an upper back cover layer is arranged under the ink-receiving layer; a cingico layer is arranged under the upper back cover layer; a lower back cover layer is arranged under the cingico layer; a flocking layer is arranged under the lower back cover layer, and the flocking layer is located on the lower end surface of the canvas; an adhesive layer is arranged between the lower back cover layer and the flocking layer.

Preferably, the lower end surface of the upper back cover layer is attached to the upper end surface of the cingico layer.

Preferably, the lower end surface of the cingico layer is attached to the upper end surface of the lower back cover layer.

Preferably, the ink-receiving layer is fixedly connected with the upper back cover layer.

Preferably, a method for producing the canvas flocking diamond picture comprises the following steps:

step 1: wetting a cingico layer made of chemical fiber oxford cloth, then, drying the wet cloth at a high temperature of 190° C. to take an, effect of preventing shrinking and flatting the cloth surface, thereby completing sizing of gray cloth;

step 2: coating and sealing the holes and gaps on the back surface of the cingico layer with waterborne waterproof environmental-friendly acrylic acid to form the lower back cover layer;

step 3: uniformly brushing a layer of adhesive glue on the lower back cover layer to form an adhesive layer, and sufficiently paving woolens on the adhesive layer in a manner of spraying to form a flocking layer;

step 4: coating and sealing holes and gaps, on the front surface of the cingico layer with waterborne waterproof environmental-friendly acrylic acid to form an upper back cover layer;

step 5: coating waterborne waterproof environmental-friendly acrylic emulsion on the surface of the upper back cover layer, and performing high-temperature drying at a temperature of 150° C. to form a film, namely, an ink-receiving layer;

step 6: smearing paillettes on the ink-receiving layer to form a flash layer; and

step 7: printing the patterns of the diamond picture on the flash layer, and smearing oily environmental-friendly glue at a place where the patterns are printed after printing.

Compared with the prior art, the disclosure has the beneficial effects:

1. Setting the step of wetting and drying the gray cloth of the canvas flocking diamond picture takes an effect of preventing the gray cloth from being shrunk and solves a problem that the gray cloth of the diamond canvas is shrunk when encountering water so that the diamond picture becomes uneven, thereby improving, the appearance of the diamond picture.

2. Setting of spraying glue and flocking the canvas flocking diamond picture achieves a gain effect of resisting wrinkle and preventing wrinkle, improves the appearance and texture of the diamond canvas, effectively maintains the appearance of the diamond picture, avoids that the diamond canvas forms wrinkles due to stacking and wrinkling when in transportation, and solves a problem that the back surface of the diamond picture is most made of chemical fiber cloth or cotton linen so that wrinkles are generated, thereby affecting the appearance and texture.

3. The in-receiving layer is arranged on the canvas flocking diamond picture to absorb ink sprayed from a printer so as to allow patterns to be quickly dried, thereby greatly shortening the time of drying the ink in the air and effectively preventing ink change caused by light, rubbing of hands of a worker; meanwhile, the ink-receiving layer allows the effect of the diamond picture to be better and makes color restoration more real.

### DESCRIPTION OF THE DRAWINGS

FIG. 1 is a front view of a canvas flocking diamond picture according to the disclosure;

FIG. 2 is a structural diagram of a canvas flocking diamond picture according to the disclosure; and

FIG. 3 is a structural diagram of a flowchart of use method steps according to the disclosure.

In drawings, 1, picture frame; 2, protective film; 3, canvas; 4, flash layer; 5, ink-receiving layer; 6, upper back cover layer; 7, cingico layer; 8, lower back cover layer; 9, adhesive layer; 10, flocking layer.

### DETAILED DESCRIPTION OF PREFERRED EMBODIMENTS

Next, the technical solution in embodiments of the disclosure will be clearly and completely described in combination with drawings in embodiments of the disclosure, apparently, the described embodiments are only one part of embodiments of the disclosure but not all the embodiments.

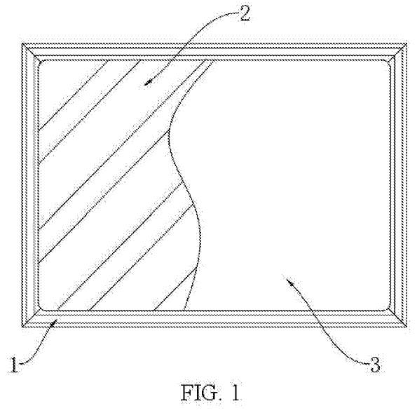

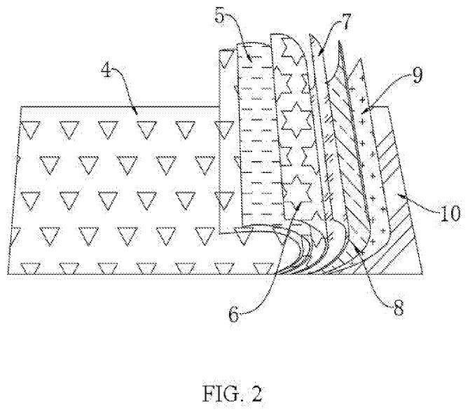

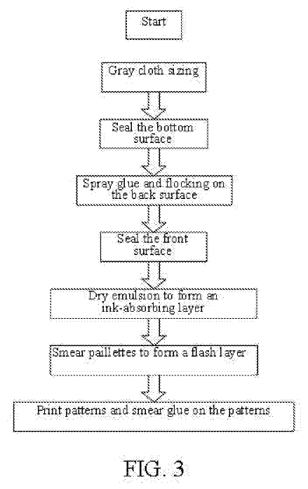

Referring to FIGS. 1-3, an embodiment provided by the disclosure is as follows: a canvas flocking diamond picture comprises a picture frame 1, wherein, the picture frame 1 is internally provided, with a protective film 2 and a canvas 3, and the protective film 2 is located at one side of the canvas 3; the upper end surface of the canvas 3 is provided with a flash layer 4; an ink-receiving layer 5 is arranged under the flash layer 4; an upper back cover layer 6 is arranged under the ink-receiving layer 5; a cingico layer 7 is arranged under the upper back cover layer 6; a lower back cover layer 8 is arranged under the cingico layer 7; a flocking layer 10 is arranged under the lower back cover layer 8, and the flocking layer 10 is located on the lower end surface of the canvas 3; an adhesive layer 9 is arranged between the lower back cover layer 8 and the flocking layer 10.

Further, the lower end surface of the upper back cover layer 6 is attached, to the upper end surface of the cingico layer 7.

Further, the lower end surface of the cingico layer 7 is attached to the upper end surface of the lower back cover layer 8.

Further, the ink-receiving layer 5 is fixedly connected with the upper back cover layer 6.

Further, a method for producing the canvas flocking diamond picture comprises the following steps:

step 1: after wetting a cingico layer 7 made of chemical fiber oxford cloth, drying the wet cloth at a high temperature of 190° C. to take an effect of preventing shrinking and flatting the cloth surface, thereby completing the sizing of gray cloth;

step 2: coating and sealing holes and gaps on the back surface of the cingico layer 7 with waterborne waterproof environmental-friendly acrylic acid to form a lower back cover layer 8;

step 3: uniformly brushing a layer of adhesive glue on the lower back cover layer 8 to form an adhesive layer 9, and paving woolens on the adhesive layer 9 in a manner of spraying to form a flocking layer 10;

step 4: coating and sealing holes and gaps on the front surface of the cingico layer 7 with waterborne waterproof environmental-friendly acrylic acid to form an upper back cover layer 6;

step 5: coating waterborne waterproof environmental-friendly acrylic emulsion on the surface of the upper back cover layer 6, and drying at a high temperature of 150° C. to form a film, namely, an ink-receiving layer 5;

step 6: smearing paillettes on the ink-receiving layer 5 to form a flash layer 4; and

step 7: printing the patterns of the diamond picture on the flash layer 4, and, smearing oily environmental-friendly glue at a place where the patterns are printed after printing.

It is apparent for those skilled in the art that the disclosure is not limited to details of the above exemplary embodiment and can be achieved in other particular forms without departing from the spirit or basic features of the disclosure. Thus, regardless of which points, embodiments should be deemed as being exemplary and non-limiting. The scope of the disclosure is defined by appended claims rather than the above description, and therefore it is intended that all changes coming within the meanings and scope of equivalent elements of claims are included in the disclosure. Any reference numbers in claims should not be considered as limiting the involved claims.

We claim:

1. A canvas flocking diamond picture, comprising a picture frame (1), wherein, the picture frame (1) is internally provided with a protective film (2) and a canvas (3), and the protective film (2) is located at one side of the canvas (3); the upper end surface of the canvas (3) is provided with a flash layer (4); an ink-receiving layer (5) is arranged under the flash layer (4); an upper back cover layer (6) is arranged under the ink-receiving, layer (5); a cingico layer (7) is arranged under the upper back cover layer (6); a lower back cover layer (8) is arranged under the cingico layer (7); a flocking layer (10) is arranged under the lower back cover layer (8), and the flocking layer (10) is located on the lower end surface of the canvas (3); an adhesive layer (9) is arranged between the lower back cover layer (8) and the flocking layer (10).

2. The canvas flocking, diamond picture according to claim 1, wherein, the lower end surface of the upper back cover layer (6) is attached to the upper end surface of the cingico layer (7).

3. The canvas flocking diamond picture according to claim 1, wherein, the lower end surface of the cingico layer (7) is attached to the upper end surface of the lower back cover layer (8).

4. The canvas flocking diamond picture according to claim 1, wherein, the ink-receiving layer (5) is fixedly connected with the upper back cover layer (6).

5. The canvas flocking diamond picture according to claim 1, wherein, a method for producing the canvas flocking diamond picture comprises the following steps:
step 1: after wetting a cingico layer (7) made of chemical fiber oxford cloth, drying the wet cloth at a high temperature of 190° C. to take an effect of preventing, shrinking and flatting a cloth surface, thereby completing sizing of gray cloth;
step 2: coating and sealing holes and gaps on the back surface of the cingico layer (7) with waterborne waterproof environmental-friendly acrylic acid to form a lower back cover layer (8);
step 3: uniformly brushing a layer of adhesive glue on the lower back cover layer (8) to form an adhesive layer (9), and sufficiently paving woolens on the adhesive layer (9) in a manner of spraying to form a flocking layer (10);
step 4: coating and sealing holes and gaps on the front surface of the cingico layer (7) with waterborne waterproof environmental-friendly acrylic acid to form an upper back cover layer (6);
step 5: coating waterborne waterproof environmental-friendly acrylic emulsion on the surface of the upper back cover layer (6), and performing high-temperature drying at a temperature of 150° C. to form a film, namely, an ink-receiving layer (5);
step 6: smearing paillettes on the ink-receiving layer (5) to form the flash layer (4); and
step 7: printing the patterns of the diamond picture on the flash layer (4), and smearing oily environmental-friendly glue at a place where the patterns are printed after printing.
